(19) United States
(12) Patent Application Publication
(10) Pub. No.: US 2006/0083513 A1
(43) Pub. Date: Apr. 20, 2006

(54) System and apparatus for a carrier class WDM PON providing trunk protection with increased fiber utilization, distance and bandwidth

(76) Inventors: William X. Huang, San Ramon, CA (US); Jer-Chen Kuo, Davis, CA (US); Ten-Ling Ti, San Jose, CA (US); Liming Gao, Alameda, CA (US)

Correspondence Address: FELIX L. FISCHER, ATTORNEY AT LAW, 1607 MISSION DRIVE, SUITE 204, SOLVANG, CA, 93463, US

(21) Appl. No.: 10/966,416

(22) Filed: Oct. 14, 2004

(51) Int. Cl. H04J 14/02

(52) U.S. Cl. 398/83

(57) ABSTRACT

A Passive Optical Network (PON) is provided with trunk protection by employing Wavelength Division Multiplexer (WDM) elements in combination with optical couplers at distribution nodes (DN) intermediate a pair of Local Exchange Office Nodes and a customer node. The Local Exchange Office Nodes (LEON) transmitting and receiving signals on an optical fiber loop pair through a WDM with one LEON active and one backup until a failure or cable cut occurs. Each DN drops one wavelength from the downstream loop with an AD/DRWDM and employs an Optical-Electrical-Optical (OEO) repeater to amplify the downstream signal and an OEO to amplify the upstream signal before insertion onto the upstream loop by the AD/DRWDM. The DN incorporates a second WDM for multiplexing the signals from and into the OEOs and connecting through an optical coupler to multiple user nodes.

### BACKGROUND OF THE INVENTION

1. Field of the Invention

This invention relates generally to the field of telecommunications network transmission systems and, more particularly, to a wavelength division multiplexing Passive Optical Network (PON) that provides trunk protection, extended usable distance, increased fiber utilization and through the combination of Wavelength Division Multiplexing technology and line power feed by twisted pair routed from a Local Exchange Office with the fiber cable.

2. Description of the Related Art

Existing Passive Optical Networks are commonly found in use for broadband fiber optic access network. The PON uses a means of sharing fiber to the home without running individual fiber optic lines from an exchange point, telephone company Local Exchange Office (LEO) or a CATV Headend to the subscriber's home.

Present Passive Optical Networks are limited to a split number of 32 when the transport speed is higher than 600 Mb/s. It is therefore desirable to provide PON systems with repeater capability to increase the number of splits while maintaining the transport speed.

Additionally, existing PONs are limited to a link distance of between 10 and 20 km. This limitation is exacerbated as the number of splits is increased due to the reduction in optical power. The fiber link distance must be limited to accommodate the split loss. It is therefore desirable to provide a PON system which allows greater link distance while maintaining the split capability.

Finally, current PONs use tree and branch architectures which require deployment of redundant tree and/or branch capability which essentially doubles the cost of the fiber loop. It is therefore desirable to provide a simplified architecture for fiber loop protection without unnecessary duplication of hardware.

### SUMMARY OF THE INVENTION

A Passive Optical Network (PON) incorporating the present invention employs an exchange office having two Local Exchange Office Nodes (LEON) with each LEON having a first Wavelength Division Multiplexer (WDM) for transmission of M wavelengths in the upstream direction and a second WDM for transmission of M wavelengths in the downstream direction. An optical fiber loop comprising a fiber pair with one fiber connected to the first WDM in each LEON and a second fiber connected to the second WDM in each LEON provides upstream and downstream transmission. M distribution nodes (DN) each having an Add/Drop (AD/DR)WDM connected to the fiber loop pair to add or drop a selected wavelength from the M wavelengths transmitted on the optical fiber. A first Optical-Electrical-Optical (OEO) repeater is connected to the AD/DR WDM to take the wavelength dropped by the AD/DRWDM for amplifying the downstream signal and converting to a commonly used wavelength band (for example 1550 nm). A second OEO is connected to the AD/DRWDM for amplifying the upstream signal from a commonly used wavelength band (for example 1310 nm) and converting to the add/drop wavelength for the AD/DRWDM, which then adds the wavelength to the optical fiber in the upstream direction.

An additional two channel WDM (in this example, 1550/1130 nm) is connected to the first and second OEOs, for multiplexing of the upstream and downstream signals, and to a 1×N optical coupler. N customer nodes are each connected to a leg of the coupler. Each DN add/drops a selected wavelength to allow the connected customer nodes to receive and transmit via a respective one of the wavelengths on the optical fiber loop.

### BRIEF DESCRIPTION OF THE DRAWINGS

These and other features and advantages of the present invention will be better understood by reference to the following detailed description when considered in connection with the accompanying drawings wherein:

FIGS. 1a-e are block diagrams showing the various PON configurations in which the present invention can be employed;

FIG. 2 is a block diagram the elements of a system embodying the present invention;

FIG. 3a is a block diagram depiction of the downstream broadcast transmission employed in the PON;

FIG. 3b is a block diagram depiction of the upstream Time Domain Multiplexing Access (TDMA) employed in the upstream transmission on the PON;

FIGS. 4a and 4b are block diagrams of the normal transmission directions for communication on the system employing the present invention; and

FIGS. 5a and 5b are block diagrams of the transmission directions for communication on the system after a break in the fiber optic ring.

### DETAILED DESCRIPTION OF THE INVENTION

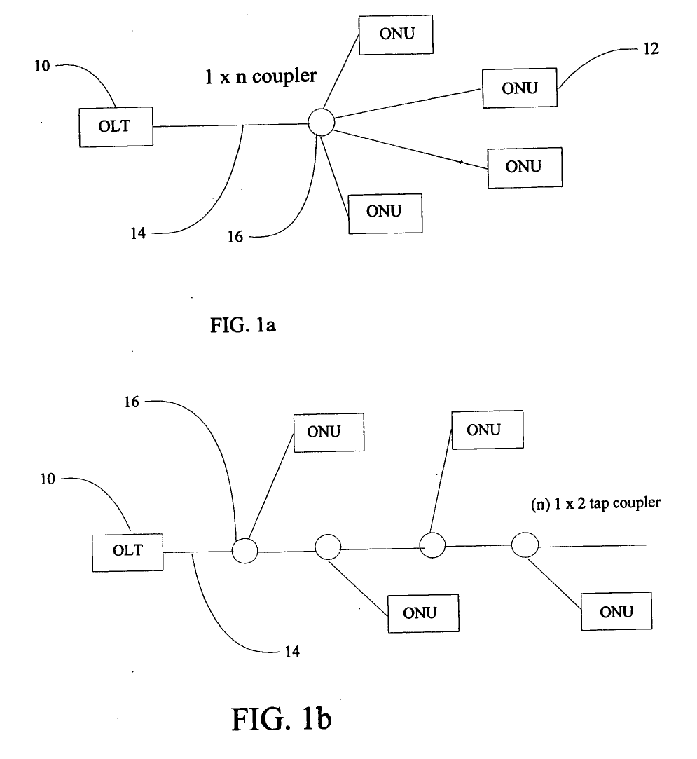

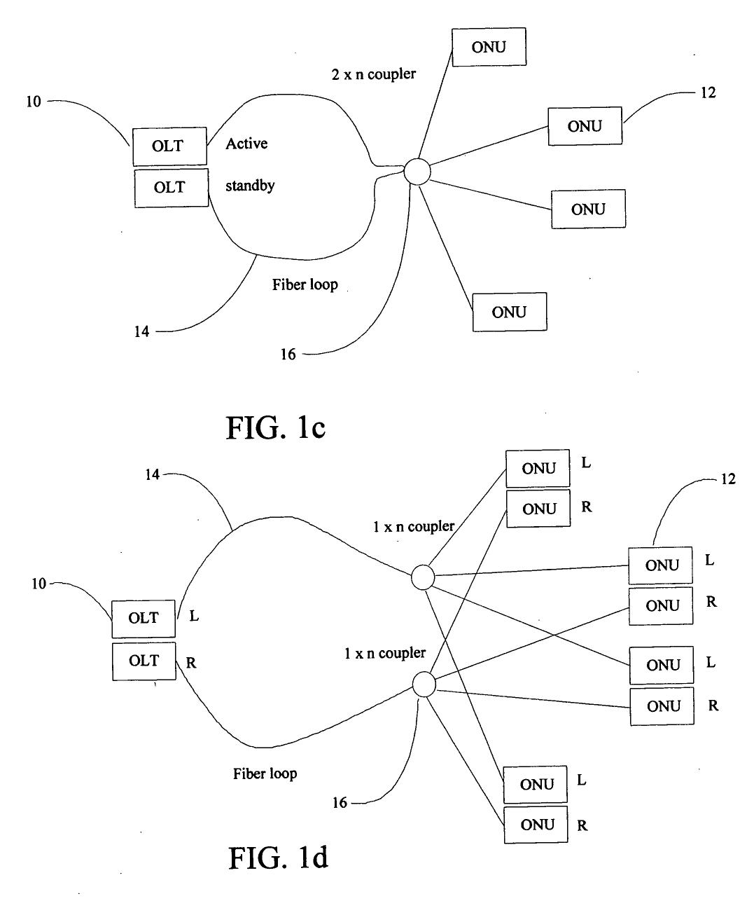

Referring to FIGS. 1a-e, a passive optical network (PON) is a system that brings Optical Fiber cabling and signals all or most of the way to the end user. Depending on where the PON terminates, the system can be described as fiber-to-the-curb (FTTC), fiber-to-the-building (FTTB), or fiber-to-the-home (FTTH). A PON consists of an Optical Line Termination (OLT) 10 at the communication company's Local Exchange Office and a number of Optical Network Units (ONUs) 12 near end users. Typically, up to 32 ONUs can be connected to an OLT. The term “passive” simply describes the fact that optical transmission has no power requirements or active electronic parts once the signal is going through the network. The main components in PON are Optical Fiber 14 and Couplers 16. Each coupler combines or splits power from optical fibers. It is used in the PON to distribute optical signal to and from multiple subscriber lines.

FIG. 1a discloses a PON with a basic tree structure wherein the ONUs are connected to the OLT through one 1×n coupler from a single optical fiber to a branch optical fiber for each ONU. FIG. 1b discloses a bus structure in which each ONU has a separate coupler (n 1×2 couplers) on a single optical fiber “bus”.

FIG. 1c discloses a PON with a trunk protected tree wherein two OLTs are present on a fiber optic loop with one OLT active and one standby. The coupler is a 2×n to accommodate the two “halves” of the loop connecting with the OLTs. FIG. 1d discloses a fully redundant tree with two OLTs, as in the trunk protected tree, with a 1×n coupler at the termination point of the fiber optic loop and each user location has two ONUs, one communicating through each of the couplers to the respective live or redundant OLT.

FIG. 1e shows a fully redundant bus architecture with two OLTs and two ONUs at each user location connected to the fiber loop bus through a 2×2 coupler.

A PON employing the present invention allow shared costs of fiber and much of the equipment located with the service provider among several customers, while also eliminating expensive, powered equipment between the service provider and these customers. The optical path is “transparent” to bit rate, modulation format (e.g., digital or analog), and protocol (e.g., SONET/SDH, IP, Ethernet). Such transparency results from nothing being installed between the service provider and the customer which is specific to the bit rate, modulation format, etc., allowing services to be mixed or economically upgraded in the future as needed. New services and/or new customers can be added by changing service-specific equipment only at the ends of the network, and only for those customers affected. Such flexibility is not the case in most of today's other access network architectures.

The present invention provides (1) a ring type fiber loop for fiber trunk protection; (2) a multiple wavelength WDM system to increase fiber utilization with fiber drops to multiple distribution nodes; (3) Optical-Electrical-Optical (OEO) repeater/wavelength converters for use in the fiber distribution node boost the optical power, allowing more splits, extending overall effective fiber distance and converting to a commonly used wavelength band for example 1550/1310 nm that allows User Nodes connected to the distribution node to only have a single wavelength band for reducing inventory cost; and, (4) Powers the OEO by a twisted paired routed along with the optical cable to solve the local power problem for each distribution node.

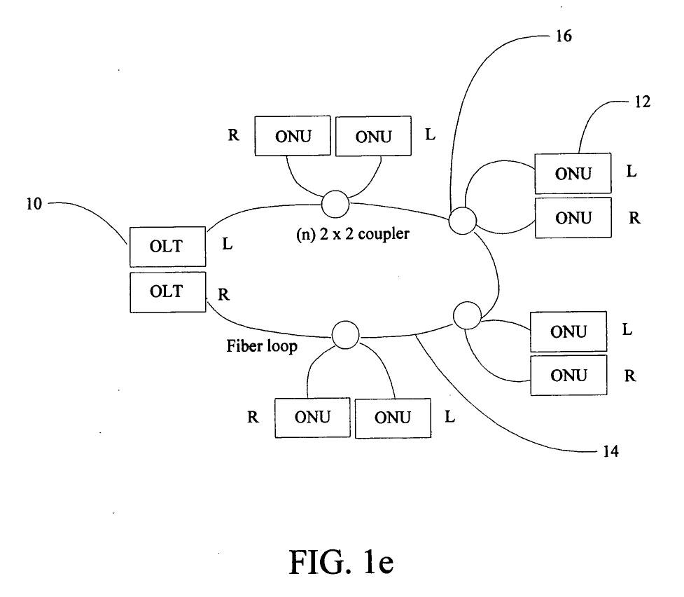

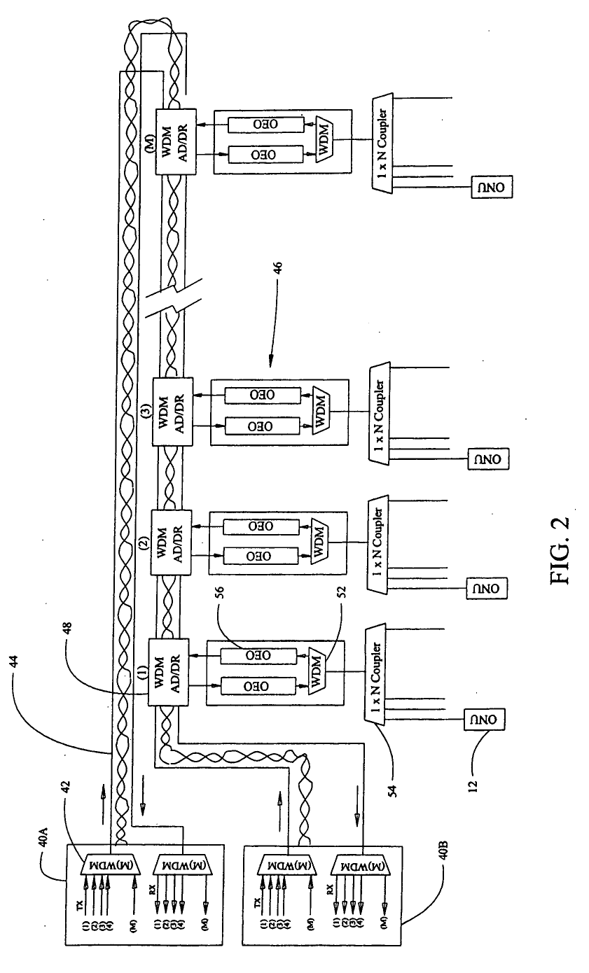

As shown in FIG. 2, two Local Office Exchange Nodes (LOEN) 40 are employed, each having two M wavelength capable Wavelength Division Multiplexers (WDM) 42, (an exemplary embodiment provides eight channels, i.e. 1470, 1490, 1510, 1530, 1550, 1570, 1590, 1610 nm). Each Distribution Node (DN) selects one specific wavelength for upstream transmissions and downstream transmissions. A dual fiber ring 44 connects the upstream WDMs and downstream WDMs with one of the fiber pair for upstream transmission and the other fiber of the pair for downstream transmission and one LOEN acting as primary and the other acting as backup. An exemplary WDM employed in intended embodiments of the invention as described for the LEON is manufactured by Optowaves, Inc. 780 Montague Expressway, Suite 403, San Jose, Calif. 9513 with part number CWDM-8-1470-1-SC'UPC.

Multiple distribution nodes (DN) 46 are connected to the fiber loops, each having an Add/Drop (AD/DR) WDM 48. M wavelengths are multiplexed in the fiber. Each wavelength carries a modulated Passive Optical Network protocol with downstream broadcast and upstream TDM as described above. Along the fiber cable, one specific wavelength (color) is captured by the AD/DRWDM in each distribution node. In a system employing M wavelengths, a total of M distribution nodes are in the loop, each node dropping a specific wavelength (color). Since only one wavelength is added/dropped from the optical fiber, the remaining wavelengths are unaffected by the DN split thereby allowing greater link distance.

In the distribution node, the optical signal is added/dropped from the WDM, converted to a commonly used wavelength (for example, 1550 nm downstream and 1310 nm upstream) by the OEO 50 and amplified. The signal is then processed through a second WDM 52 (in this example 1550/1310 nm WDM) and fanned out through a 1×N Optical Coupler 54 to connect to N ONUs 12 from the DN. Upstream transmissions are received in the DN by the second WDM and processed through a second OEO 56 for insertion by the AD/DRWDM 48 onto the fiber loop. For an exemplary DN adding and dropping a wavelength of 1470 nm from the optical fiber loop, a WDM manufactured by Optowaves, Inc. 780 Montague Expressway, Suite 403, San Jose, Calif. 95131 with part number CWDM-1-1470-1-SC/UPC is employed. Exemplary hardware for creating the capability of the OEO is a CWDM transceiver back to back with a standard PON transceiver, For example, a standard PON transceiver is 1490 nm downstream/1310 nm upstream. CWDM transceivers are available as 1470/1490/1510/1530/1550/1570/1590/1610 nm. In FIG. 2, the exemplary OEO1 is DN 1470/1490 and UP 1310/1470, OEO 2 is DN 1490/1490 and UP 1310/1490, OEO 3 is DN 1510/1490 and UP 1310/1510, and so on.

In an exemplary embodiment, the amplification by the OEOs provides optical power boosting, which allows the trunk distance to reach 40 km while split number is maintained at 32. The wavelength conversion allows the User Node to be unified to one wavelength band which reduces the inventory cost of the User Node. An exemplary WDM employed in intended embodiments of the invention as described for the second WDM in the DN is manufactured by Optowaves, Inc. 780 Montague Expressway, Suite 403, San Jose, Calif. 95131 with part number HWDM2-131-1-09-SC/UPC-A

Power feed is provided to the DN by a twisted copper wire pair 54 along the fiber ring 44. A power failure in the Distribution Node will not affect other nodes in the loop because the fiber ring is still maintained passive (only fiber and WDM).

For the system employing the invention as shown, the total number of User Nodes=(Number of Core in fiber cable/2)×M×N. An example of a 36 core fiber, 8 wavelengths, and 1×32 split, a total of 4,608 ONUs can be supported.

In normal operation, the optical signal is sent from only one direction by the active LEON on the fiber ring. In case of a fiber cable cut, the backup LEON begins operation and the optical signal is sent in both directions on the fiber ring. User nodes synchronize to the downstream signal received. For example, if a fiber cable is cut between DNs 3 and 4, DNs 1, 2 and 3 will synchronize to the same direction of optical signal employing one LEON and DNs 4 to M will synchronize to another direction of optical signal connected to the other LEON. This provides trunk protection for the fiber loop.

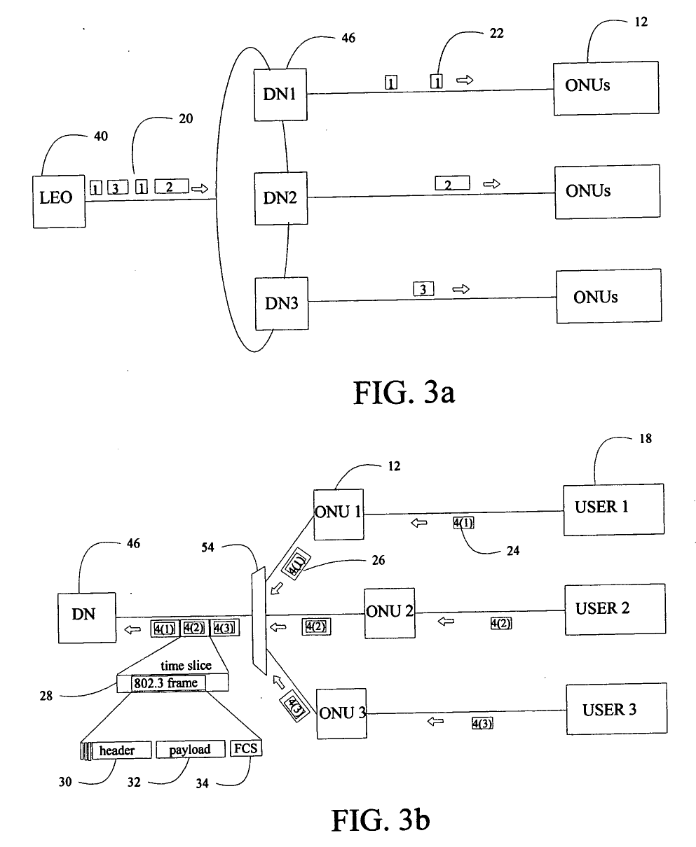

As shown in FIG. 3a, the PON employs a true broadcast for downstream transmission from the LEO to the DNs which then drop a designated wavelength. Each ONU receives a specific wavelength 22 from the multi wavelength broadcast 20. For upstream transmission, the PON employs a Time Division Multiple Access format as shown in FIG. 3b. The upstream transmissions from a user on a specific wavelength 24 are collated into a frame by the ONU which is then time sliced with transmissions from the other ONUs through the coupler to the DN. Each frame 28 for a specific wavelength carries header 30, payload 32 and FCS 34. The DN then adds that wavelength to the fiber loop for transmission to the LEO.

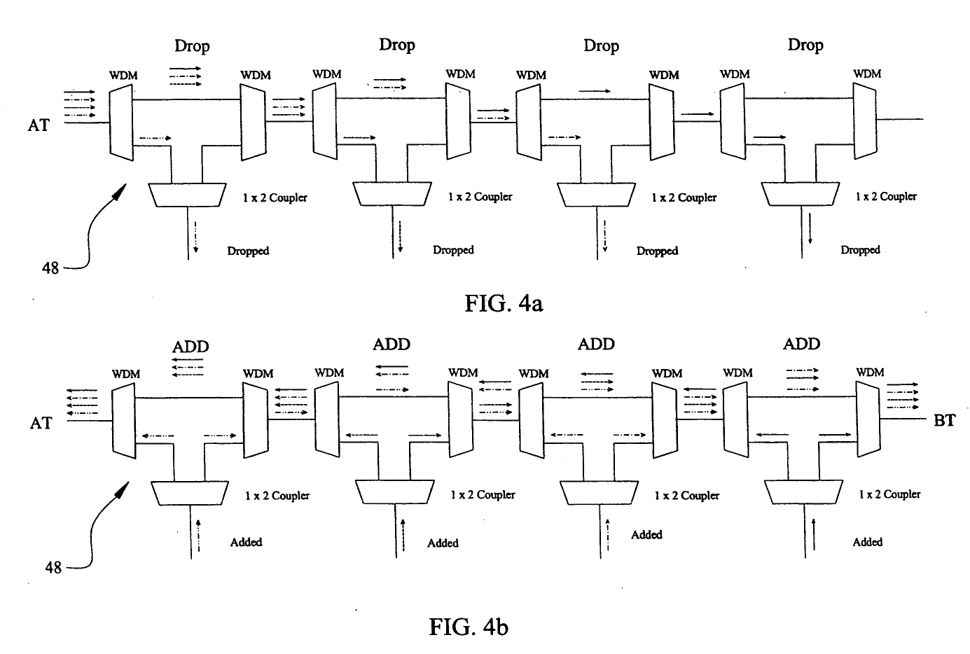

As shown in FIGS. 4a and 4b for four representative DNs (DN2, DN3, DN4 and DN5 from the 1−M DNs on the fiber optic loop in FIG. 3), the AD/DR WDM 48 in each DN has functional elements including a “left WDM” and a “right WDM” for receiving and transmitting in both directions of the optical fiber loop and a 1×2 coupler for the added and dropped wavelength for the particular DN. As shown in FIG. 4a, under normal conditions, LEON A (40A in FIG. 3) transmits all wavelengths and each DN drops a particular wavelength 60a, 62a, 64a and 66a respectively for communications to the User Nodes connected to the DN. For communication from the User Nodes as shown in FIG. 4b, each DN adds the respective wavelength 60b, 62b, 64b and 66b respectively through the AD/DR WDM, however, the added wavelengths are transmitted in both directions on the loop with both LEON A the active LEON and LEON B (40B in FIG. 2) the standby LEON receiving all wavelengths transmitted by User Nodes onto the loop.

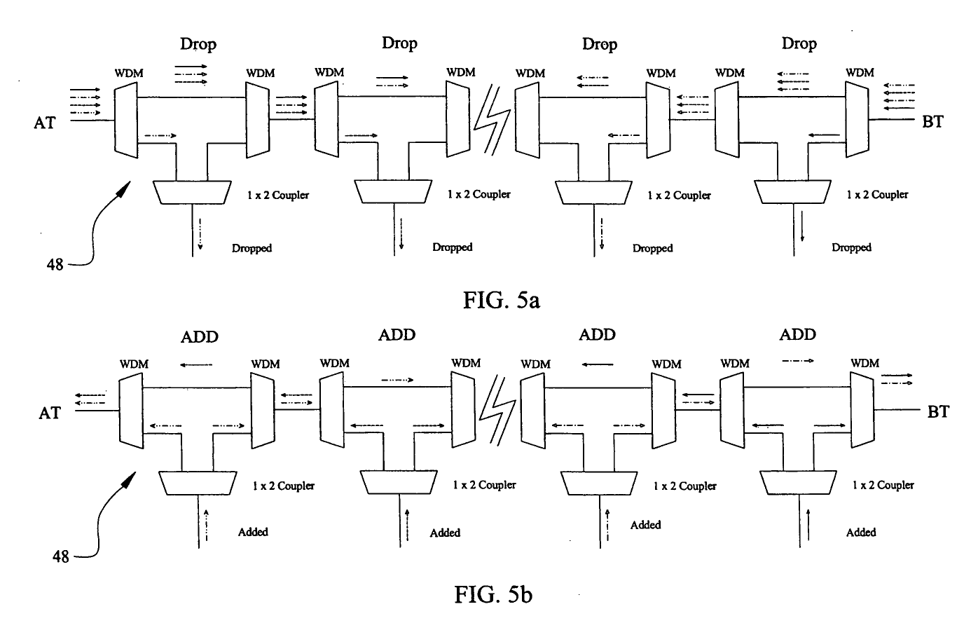

If a break occurs on the loop between DN3 and DN4 as shown in FIGS. 5a and 5b, LEON B will stop receiving wavelengths 60b and 62b and LEON A will stop receiving wavelengths 64b and 66b. Consequently the disruption can be pinpointed with respect to location and the standby LEON, LEON B, will begin transmitting while LEON A continues transmitting. This allows continued communication to all DNs and their connected User Nodes. For the embodiment shown, both LEON A and LEON B transmit all wavelengths. Communications from the User Nodes also continues without interruption since the signals added by the AD/DR WDMs in the DNs are transmitted in both directions on the loop as shown in FIG. 5b.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. A Passive Optical Network (PON) comprising:
an exchange office having two Local Exchange Office Nodes (LEON) with each LEON having a first Wavelength Division Multiplexer (WDM) for transmission of M wavelengths in the downstream direction and a second WDM for reception of M wavelengths in the upstream direction;
an optical fiber loop comprising a fiber pair with one fiber connected to the first WDM in each LEON and a second fiber connected to the second WDM in each LEON;
M distribution nodes (DN) each having an Add/Drop (AD/DR) WDM connected to the fiber loop pair, a first Electrical-Optical-Electrical (OEO) repeater connected to the AD/DRWDM for amplifying the downstream signal, a second OEO connected to the AD/DRWDM for amplifying the upstream signal, a two channel WDM connected to the first and second OEOs for multiplexing of the upstream and downstream signals and a 1×N optical coupler connected to the two channel WDM, and
N customer nodes, connected to a leg of the coupler.

2. A Passive Optical Network as defined in claim 1 wherein the AD/DRWDM in each DN drops a selected wavelength to allow the connected customer nodes to receive on a respective one of the wavelengths.

3. A Passive Optical Network as defined in claim 1 wherein the AD/DR WDM in each DN adds the selected wavelength for transmission in both directions on the fiber loop.

4. A Passive Optical Network as defined in claim 1 wherein the first LEON is active in transmitting and the second LEON is standby until a break in the fiber loop is detected at which time the second LEON begins transmitting.
